(19) United States
(12) Patent Application Publication
(10) Pub. No.: US 2024/0040521 A1
(43) Pub. Date: Feb. 1, 2024

(54) METHOD FOR INFORMATION TRANSMISSION AND DEVICE FOR FORWARDING INFORMATION EXECUTING THE SAME

(71) Applicant: Samsung Electronics Co., Ltd., Suwon-si, Gyeonggi-do (KR)

(72) Inventors: Jingxing FU, Beijing (CN); Feifei SUN, Beijing (CN); Zhe CHEN, Beijing (CN)

(21) Appl. No.: 18/359,324

(22) Filed: Jul. 26, 2023

(30) Foreign Application Priority Data
Jul. 26, 2022 (CN) 202210885963.9

(51) Int. Cl. H04W 52/52; H04W 52/32; H04W 52/24

(52) U.S. Cl. CPC H04W 52/52; H04W 52/325; H04W 52/245

(57) ABSTRACT

The disclosure relates to a 5G or 6G communication system for supporting a higher data transmission rate. The disclosure provides a method for signal transmission in a communication system is provided. The method is performed by a device for forwarding signals and includes determining a first power amplification gain, and forwarding a received signal based on the first power amplification gain.

### CROSS-REFERENCE TO RELATED APPLICATION(S)

This application is based on and claims priority under 35 U.S.C. § 119(a) of a Chinese patent application number 202210885963.9, filed on Jul. 26, 2022, in the Chinese Intellectual Property Office, the disclosure of which is incorporated by reference herein in its entirety.

### BACKGROUND

### 1. Field

The disclosure relates to a technical field of wireless communication. More particularly, the disclosure relates to a method and device for receiving and transmitting information.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Additionally, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

Moreover, as 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problem and/or disadvantages and to provide at least the advantages described below. Accordingly, an aspect of the disclosure is to provide a method for information transmission and device for forwarding information executing the same, which can improve the receiving performance of the device for forwarding information and electronic equipment such as user equipment (UE) to receive and transmit information.

Additional aspects will be set forth in part in the description which follows and, in part, will be apparent from the description, or may be learned by practice of the presented embodiments.

In accordance with an aspect of the disclosure, a method for signal transmission in a communication system is provided. The method is performed by a device for forwarding signals and includes determining a first power amplification gain, and forwarding a received signal based on the first power amplification gain.

In some examples, the method further includes prior to determining the first power amplification gain, determining power control parameters, wherein the power control parameters include a second power amplification gain configured or preset by a base station and/or a maximum transmitting power configured or preset by the base station.

In some examples, the maximum transmitting power is configured or preset through a first signaling, and the second power amplification gain is configured or preset through a second signaling, wherein the first signaling and the second signaling are same signaling or different signaling.

In other examples, the power control parameters are configured for each beam for carrying signals.

In some examples, determining the first power amplification gain includes measuring a power of the received signal and/or a power of a transmitted signal, and determining the first power amplification gain according to a measurement result.

In still other examples, determining the first power amplification gain includes for the beam carrying the signal, measuring the power of the received signal and/or the power of the transmitted signal on the beam, and determining the first power amplification gain corresponding to the beam according to the measurement result.

In some examples, determining the first power amplification gain includes measuring the power of the received signal in a first time interval, and determining a first power amplification gain according to the measured power of the received signal in a second time interval after the first time interval.

In other examples, determining the first power amplification gain includes measuring the power of the transmitted signal in a third time interval, and determining the first power amplification gain according to the measured power of the transmitted signal in a fourth time interval after the third time interval.

In some examples, at least one of the first time interval, the second time interval, the third time interval and the fourth time interval is configured and/or preset by signaling and/or determined by the implementation of the device for forwarding signals.

In still other examples, determining the first power amplification gain includes determining the first power amplification gain according to the power control parameters and the measured power of the received signal, and/or determining the first power amplification gain according to the power control parameters and the measured power of the transmitted signal.

In some examples, determining the first power amplification gain according to the power control parameters and the measured power of the received signal includes if the sum of the measured power of the received signal and the second power amplification gain is greater than the maximum transmitting power, determining that the first power amplification gain is the difference value between the maximum transmitting power and the measured power of the received signal, or determining that the first power amplification gain is the difference value between the second power amplification gain and a first variable.

In other examples, determining the first power amplification gain according to the power control parameters and the measured power of the received signal further includes if the sum of the measured power of the received signal and the second power amplification gain is less than or equal to the maximum transmitting power, determining that the first power amplification gain is the second power amplification gain.

In some examples, determining the first power amplification gain according to the power control parameters and the measured power of the transmitted signal includes if the measured power of the transmitted signal is greater than the maximum transmitting power, determining that the first power amplification gain is the second power amplification gain minus the difference value between the measured power of the transmitted signal and the maximum transmitting power, or determining that the first power amplification gain is the difference value between the second power amplification gain and a second variable.

In still other examples, determining the first power amplification gain according to the power control parameters and the measured power of the transmitted signal further includes if the measured power of the transmitted signal is less than or equal to the maximum transmitting power, determining that the first power amplification gain is the second power amplification gain.

In some examples, determining the first power amplification gain further includes determining the first power amplification gain according to whether a power amplifier for amplifying power in the device for forwarding signals is saturated.

In other examples, determining the first power amplification gain according to whether the power amplifier for amplifying power in the device for forwarding signals is saturated includes if the power amplifier for amplifying power in the device for forwarding signals is saturated, determining that the first power amplification gain is the difference value between the second power amplification gain and a third variable.

In some examples, determining the first power amplification gain according to whether the power amplifier for amplifying power in the device for forwarding signals is saturated further includes if the power amplifier for amplifying power in the device for forwarding signals is unsaturated, determining that the first power amplification gain is the second power amplification gain.

In still other examples, at least one of the first variable, the second variable and the third variable is configured and/or preset by signaling.

In some examples, the method further includes transmitting, to the base station, information related to the measurement result, and/or in case that the power amplifier for amplifying power is saturated, transmitting, to the base station, the information indicating that the power amplifier for amplifying power is saturated.

In other examples, the method further includes determining a first power amplification gain if indication information is received from the base station.

In some examples, the information related to the measurement result includes at least one of the following information the measured power of the received signal, the measured power of the transmitted signal, and the sum of the measured power of the received signal and the second power amplification gain.

In still other examples, a transmitting occasion of the information related to measurement results is triggered by signaling configuration or an event.

In some examples, triggered by an event includes the sum of the measured power of the received signal and the second power amplification gain is greater than a threshold, and/or the measured power of the transmitted signal is greater than the maximum transmitting power.

In other examples, transmitting the information related to the measurement result to the base station includes transmitting the information related to the measurement result through a physical uplink control channel (PUCCH) resource or a physical uplink shared channel (PUSCH) resource.

In accordance with another aspect of the disclosure, a device for forwarding signals is provided. The device includes a transceiver, and a processor coupled to the transceiver and configured to perform some example methods described above.

In accordance with another aspect of the disclosure, a device for forwarding signals is provided. The device includes a unit for receiving signals, a unit for forwarding signals, and a unit for amplifying power, coupled with the unit for receiving signals and the unit for forwarding signals respectively and configured to perform some example methods described above.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the disclosure;

FIG. 2A illustrates an example wireless transmission and reception paths according to an embodiment of the disclosure;

FIG. 2B illustrates an example wireless transmission and reception paths according to an embodiment of the disclosure;

FIG. 3A illustrates an example UE according to an embodiment of the disclosure;

FIG. 3B illustrates an example gNB according to an embodiment of the disclosure;

FIG. 4 illustrates an example of a signal forwarded by a repeater from a base station to a UE according to an embodiment of the disclosure;

FIG. 5 illustrates an example of a signal forwarded by a repeater from a UE to a base station according to an embodiment of the disclosure;

FIG. 6A illustrates a flowchart of a method for information transmission according to an embodiment of the disclosure;

FIG. 6B illustrates a flowchart of another method for information transmission according to an embodiment of the disclosure;

FIG. 7A is a schematic diagram illustrating a signal forwarded by a repeater from a base station to a UE according to an embodiment of the disclosure;

FIG. 7B is a schematic diagram illustrating a signal forwarded by a repeater from a UE to a base station according to an embodiment of the disclosure;

FIG. 8 illustrates a method of adjusting a power amplification gain by measuring a power of a received signal of a repeater according to an embodiment of the disclosure;

FIG. 9 illustrates a method of measuring a power of a received signal of a repeater according to an embodiment of the disclosure;

FIG. 10 illustrates a method of adjusting a power amplification gain by measuring a power of a transmitted signal of a repeater according to an embodiment of the disclosure;

FIG. 11 illustrates a method of measuring a power of a transmitted signal of a repeater according to an embodiment of the disclosure;

FIG. 12 illustrates a method of adjusting a power amplification gain by confirming whether a power amplifier is saturated according to an embodiment of the disclosure;

FIG. 13 is schematic diagrams illustrating that different beams are employed to carry signals at different time periods according to an embodiment of the disclosure; and

FIG. 14 is schematic diagrams illustrating that different beams are employed to carry signals at different time periods according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to meet the increasing demand for wireless data communication services since the deployment of fourth generation (4G) communication systems, efforts have been made to develop improved 5G or pre-5G communication systems. Therefore, or pre-5G communication systems are also called “Beyond 4G networks” or “Post-long term evolution (LTE) systems”.

In order to achieve a higher data rate, 5G communication systems are implemented in higher frequency (millimeter wave (mmWave)) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

Additionally, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In an embodiment, the transmission from base station to user equipment (UE) is called downlink, and the transmission from UE to base station is called uplink.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. It should be apparent to those skilled in the art that the following description of various embodiments of the disclosure is provided for illustration purpose only and not for the purpose of limiting the disclosure as defined by the appended claims and their equivalents.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

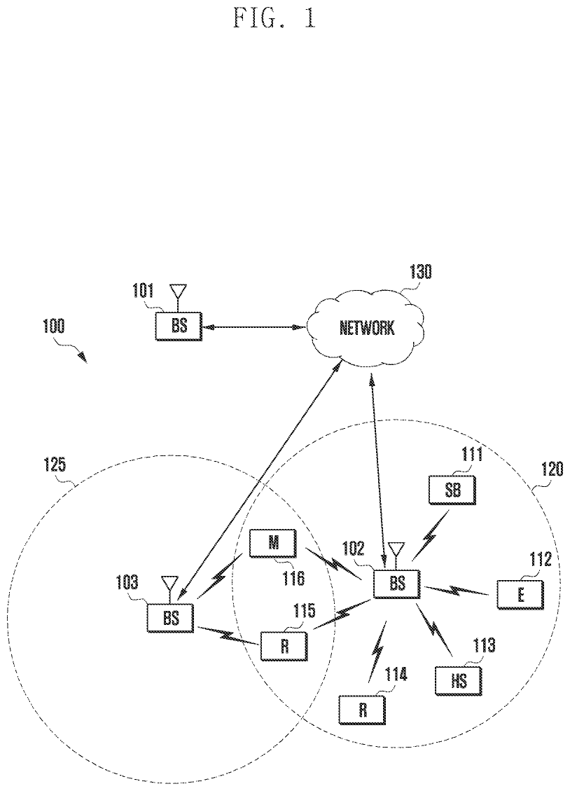

FIG. 1 illustrates an example wireless network 100 according to an embodiment of the disclosure. The embodiment of a wireless network 100 shown in FIG. 1 is for illustration only. Other embodiments of the wireless network 100 may be used without departing from the scope of the disclosure.

In an embodiment, the wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

In another embodiment, the gNB 102 provides wireless broadband access to the network 130 for a first plurality of User Equipments (UEs) within a coverage area 120 of the gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. The gNB 103 provides wireless broadband access to network 130 for a second plurality of UEs within a coverage area 125 of the gNB 103. The second plurality of UEs include a UE 115 and a UE 116. In some embodiments, one or more of the gNBs 101-103 may communicate with each other and with the UEs 111-116 using 5G, Long Term Evolution (LTE), long term evolution advanced (LTE-A), WiMAX or other advanced wireless communication technologies.

In yet another embodiment, the dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a two-dimensional (2D) antenna array as described in embodiments of the disclosure. In some embodiments, one or more of the gNB 101, the gNB 102, and the gNB 103 support codebook designs and structures for systems with 2D antenna arrays.

Although FIG. 1 illustrates an example of the wireless network 100, various changes may be made to FIG. 1. The wireless network 100 may include any number of gNBs and any number of UEs in any suitable arrangement, for example. Furthermore, gNB 101 can directly communicate with any number of UEs and provide wireless broadband access to the network 130 for those UEs. Each gNB 102-103 can directly communicate with the network 130 and provide direct wireless broadband access to the network 130 for the UEs. In addition, the gNB 101, 102 and/or 103 may provide access to other or additional external networks, such as external telephone networks or other types of data networks.

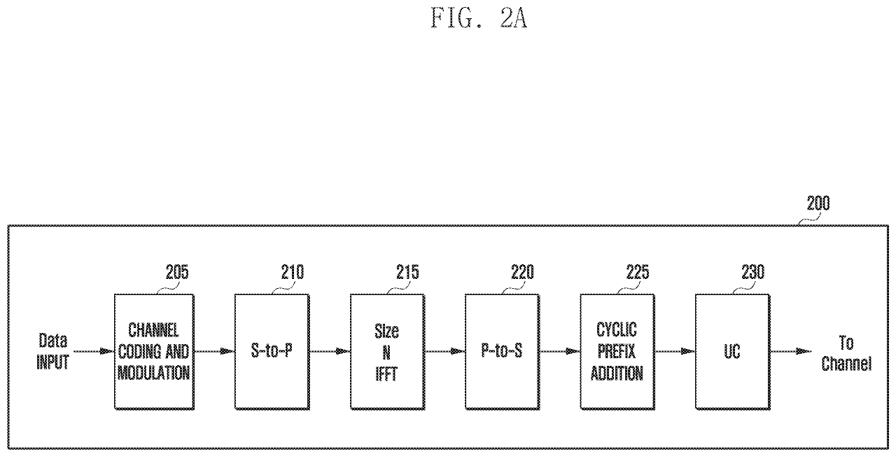

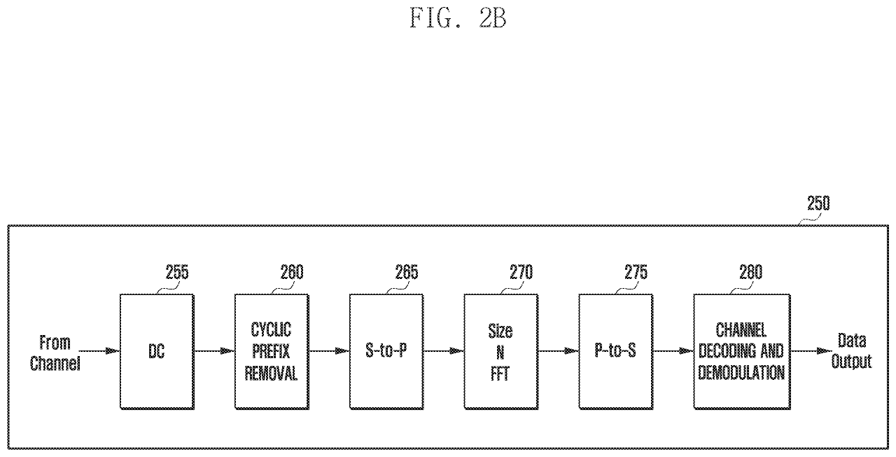

FIGS. 2A and 2B illustrate example wireless transmission and reception paths according to various embodiments of the disclosure. In the following description, a transmission path 200 can be described as being implemented in a gNB, such as the gNB 102, and a reception path 250 can be described as being implemented in a UE, such as UE 116. However, it should be understood that the reception path 250 may be implemented in a gNB and the transmission path 200 may be implemented in a UE. In some embodiments, the reception path 250 is configured to support codebook designs and structures for systems with 2D antenna arrays as described in embodiments of the disclosure.

In an embodiment, the transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. In another embodiment, the reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205, for example, receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. In another embodiment, the cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

In yet another embodiment, the RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The Serial-to-Parallel block 265 converts, for example, the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

In another embodiment, each of the gNBs 101-103 may implement a transmission path 200 similar to that for transmitting to the UEs 111-116 in the downlink, and may implement a reception path 250 similar to that for receiving from the UEs 111-116 in the uplink. Each of the UEs 111-116 may implement a transmission path 200 for transmitting to the gNBs 101-103 in the uplink, and may implement a reception path 250 for receiving from the gNBs 101-103 in the downlink.

In an embodiment Each of the components in FIGS. 2A and 2B may be implemented using only hardware, or using a combination of hardware and software/firmware. In an example, at least some of the components in FIGS. 2A and 2B may be implemented in software, while other components may be implemented in configurable hardware or a combination of software and configurable hardware. In another example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components may be added according to specific requirements. Furthermore, FIGS. 2A and 2B are intended to illustrate examples of types of transmission and reception paths that can be used in a wireless network. Any other suitable architecture can be used to support wireless communication in a wireless network.

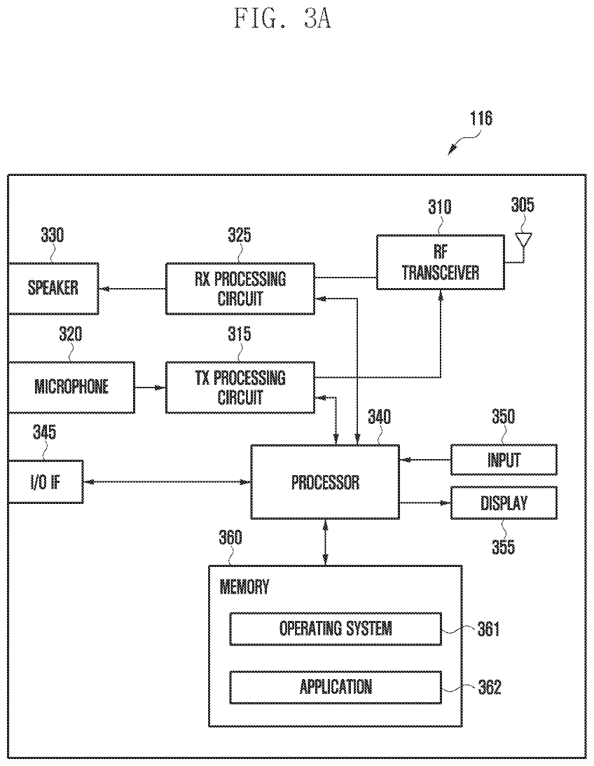

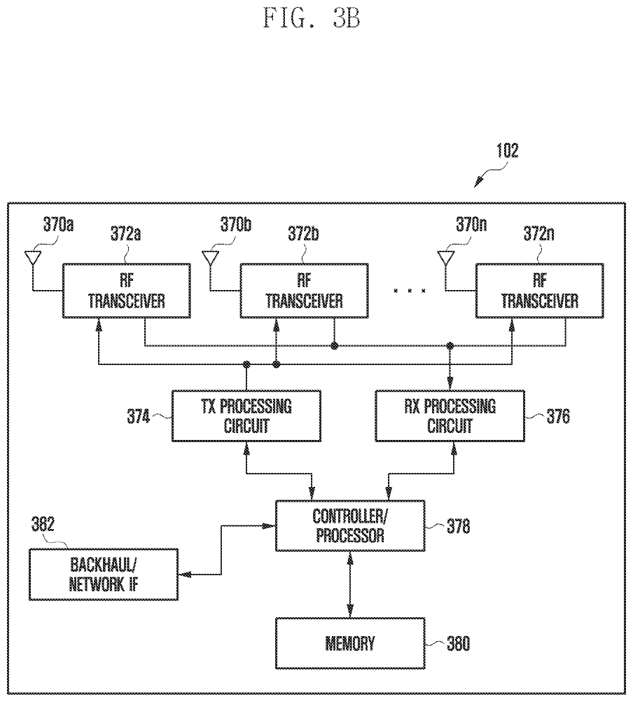

FIG. 3A illustrates an example the UE 116 according to an embodiment of the disclosure. The embodiment of the UE 116 shown in FIG. 3A is for illustration only, and the UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

In an embodiment, the RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

In another embodiment, the TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. In yet another embodiment, the RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of UE 116. In an example, the processor/controller 340 may control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. For example, the processor/controller 340 may move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 may also be coupled to the input device(s) 350 and the display 355. An operator of UE 116 may input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. In an example, various components in FIG. 3A can be combined, further subdivided or omitted, and additional components may be added according to specific requirements. In a specific example, the processor/controller 340 may be divided into a plurality of processors, such as one or more central processing units (CPUs) and one or more graphics processing units (GPUs). Although FIG. 3A illustrates that the UE 116 is configured as a mobile phone or a smart phone, UEs may be configured to operate as other types of mobile or fixed devices.

FIG. 3B illustrates an example the gNB 102 according to an embodiment the disclosure. The embodiment of the gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that the gNB 101 and the gNB 103 may include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In some embodiments, one or more of the plurality of antennas 370a-370n include a 2D antenna array. gNB 102 also includes a controller/processor 378, a memory 380, and a backhaul or network interface 382.

The RF transceivers 372a-372n receive an incoming RF signal from the antennas 370a-370n, such as a signal transmitted by UEs or other gNBs. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to controller/processor 378 for further processing.

In an embodiment, the TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

In another embodiment, the controller/processor 378 may include one or more processors or other processing devices that control the overall operation of gNB 102. In an example, the controller/processor 378 may control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. In another example, the controller/processor 378 may perform a Blind Interference Sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

In still another embodiment, the controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

In yet another embodiment, the controller/processor 378 is also coupled to the backhaul or network interface 382. The backhaul or network interface 382 allows the gNB 102 to communicate with other devices or systems through a backhaul connection or through a network. The backhaul or network interface 382 may support communication over any suitable wired or wireless connection(s). In an example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network the interface 382 can allow the gNB 102 to communicate with a larger network, such as the Internet, through a wired or wireless local area network or through a wired or wireless connection. The backhaul or the network interface 382 includes any suitable structure that supports communication through a wired or wireless connection, such as an Ethernet or an RF transceiver.

The memory 380 is coupled to the controller/processor 378. A part of the memory 380 may include an RAM, while another part of the memory 380 may include a flash memory or other ROMs. In embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with frequency division duplex (FDD) cells and time division duplex (TDD) cells.

Although FIG. 3B illustrates an example of gNB 102, various changes may be made to FIG. 3B. For example, gNB 102 may include any number of each component shown in FIG. 3A. As a specific example, the access point may include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

It can be understood that the scheme provided by embodiments of the application can be applied to, but not limited to, the wireless network described above.

An embodiment of the disclosure are further described below in conjunction with the accompanying drawings.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

In wireless communication networks, to enhance network coverage, signals from base stations to user equipment (UE) and from UE to base stations may be forwarded through network devices (the signals can include data and/or control information and/or reference signals, and control information can also be called control signaling). The name of the network device for forwarding information is not limited in embodiments of the application, and it can be called as repeater, smart repeater, relay, relay device or other names. Additionally, a network device for forwarding information may include a unit for receiving signals, a unit for forwarding signals and a unit for amplifying power, and their names are not limited in embodiments of the application. For example, a unit for receiving signals can be called as receiver, a unit for forwarding signals can be called as transmitter, and a unit for amplifying power can be called as power amplifier. For the convenience of description, the repeater, the receiver, the transmitter and the power amplifier are used as examples for description in embodiments of the application.

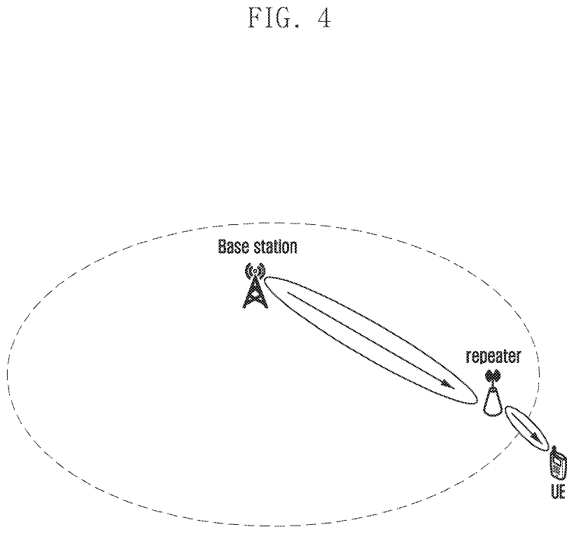

FIG. 4 illustrates an example of a signal forwarded by a repeater from a base station to a UE according to an embodiment of the disclosure.

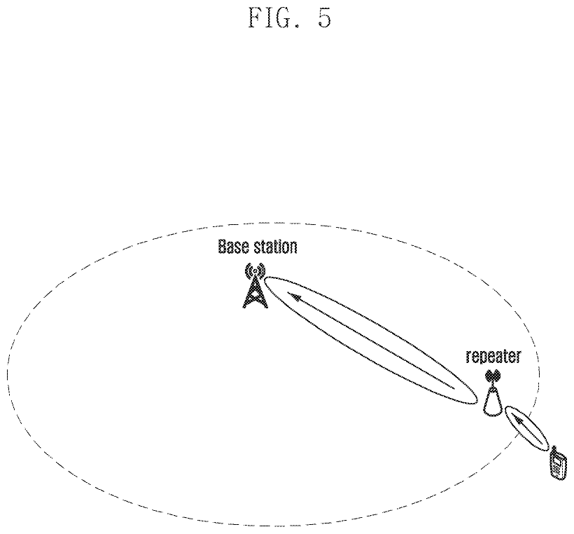

FIG. 5 illustrates an example of a signal forwarded by a repeater from a UE to a base station according to an embodiment of the disclosure.

The repeater can forward the information from the base station to the UE, as shown in FIG. 4, or the repeater can also forward the information from the UE to the base station, as shown in FIG. 5. The repeater may also receive the information transmitted by the base station without forwarding it to the UE, or the repeater can also transmit information to the base station, wherein the information is not transmitted by the receiving UE. Forwarding the information by the repeater herein may refer to the repeater directly forwards the radio frequency without decoding the information, while receiving the information by the repeater may refer to the repeater decodes the received information.

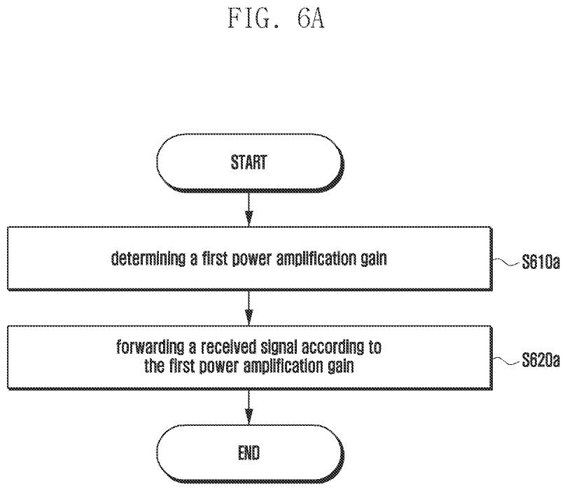

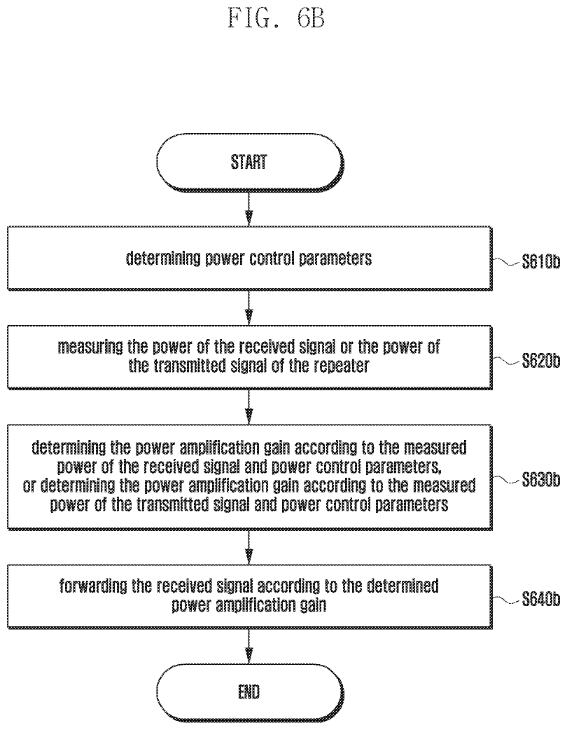

FIG. 6A illustrates a flowchart of a method 600a for information transmission according to an embodiment of the disclosure. The method 600a is implemented on the repeater side.

Referring FIG. 6A, in operation S610a of method 600a, a first power amplification gain is determined,

In operation S620a, the received signal is forwarded according to the first power amplification gain.

FIG. 6B illustrates a flowchart of another method 600b for information transmission according to an embodiment of the disclosure. The method 600b is implemented on the repeater side.

Referring to FIG. 6B, in operation S610b of method 600b, power control parameters are determined.

In operation S620b, the power of the received signal or the power of the transmitted signal of the repeater is measured.

In operation S630b, the power amplification gain may be determined according to the measured power of the received signal and power control parameters, or the power amplification gain is determined according to the measured power of the transmitted signal and power control parameters.

In operation S640b, the received signal is forwarded according to the determined power amplification gain.

The power control parameters include the power amplification gain of the repeater and the maximum transmitting power of the repeater.

The power control parameters can be determined or preset by receiving the information of the base station.

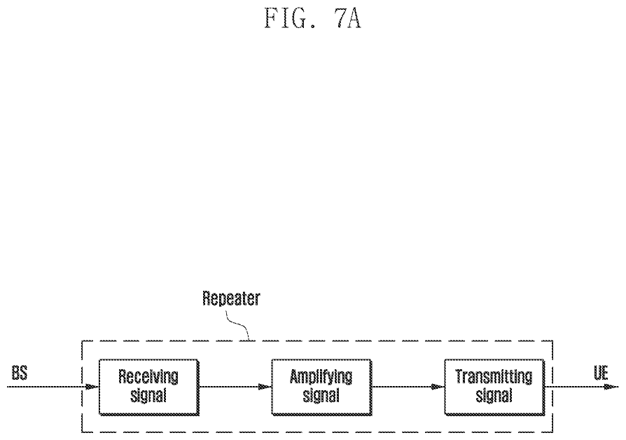

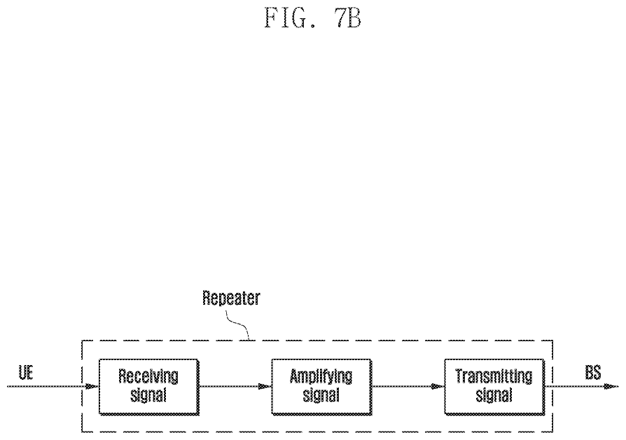

FIG. 7A is a schematic diagram illustrating a signal forwarded by a repeater from a base station to a UE according to an embodiment of the disclosure.

FIG. 7B is a schematic diagram illustrating a signal forwarded by a repeater from a UE to a base station according to an embodiment of the disclosure.

Referring to FIGS. 7A and 7B, the repeater receives the signal transmitted by the base station (or UE), amplifies the received signal, and then forwards the amplified signal to the UE (or the base station).

To prevent the power of the transmitted signal of the repeater from exceeding the maximum transmitting power of the repeater, and causing serious interference and the saturation of the repeater that distorts the signal, the power amplification gain of the repeater may be adjusted according to the power of the receiving signal of the repeater.

According to embodiments of the disclosure, the maximum transmitting power of the repeater may be determined or preset by receiving a first signaling, the first signaling can be higher layer signaling, or media access layer (MAC) signaling, or physical layer signaling (such as downlink control information (DCI)).

The power amplification gain of the repeater may be determined or preset by receiving a second signaling, the second signaling may be higher layer signaling, media access layer signaling, or physical layer signaling (such as downlink control information (DCI)).

In an embodiment, when the signal is received by the repeater, the repeater does not know the power of the received signal. If the repeater amplifies the received signal according to the initially determined power amplification gain directly and then forwards the amplified signal, the power of the transmitted signal may be greater than the maximum transmitting power of the repeater, or the power amplifier of the repeater may be saturated, which may distort the forwarded signal.

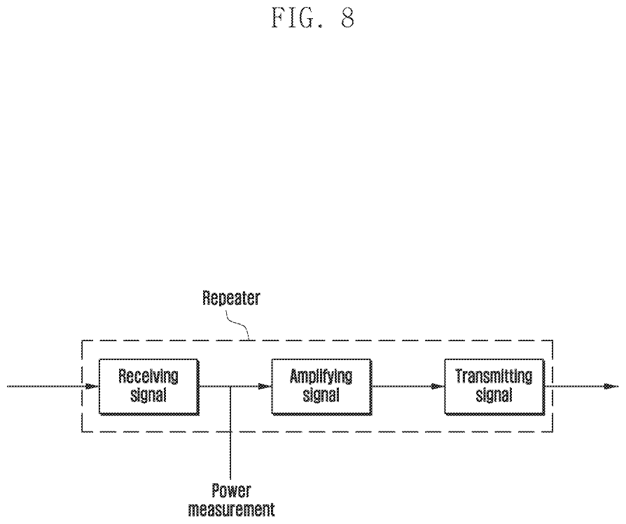

FIG. 8 illustrates a method of adjusting a power amplification gain by measuring a power of a received signal of a repeater according to an embodiment of the disclosure.

Referring to FIG. 8, in some examples, the power P1 of the received signal of the repeater may be measured at the receiving end of the repeater. In an embodiment, if the sum of the measured power P1 of the received signal and the power amplification gain beta is less than or equal to the maximum transmitting power of the repeater, the repeater amplifies the received signal according to the power amplification gain beta and forwards the amplified received signal. In another embodiment, if the sum of P1 and the power amplification gain beta is greater than the maximum transmitting power of the repeater, the power amplification gain of the repeater is adjusted as the difference value between the maximum transmitting power and P1, and the repeater amplifies the received signal according to the adjusted power amplification gain, and then forwards the amplified received signal. The advantage of this method is that it can ensure that the power of the transmitted signal of the repeater will not be greater than the maximum transmitting power of the repeater.

Referring to FIG. 8, in other examples, if the sum of the measured power P1 of the received signal and the power amplification gain beta is less than or equal to the maximum transmitting power of the repeater, the repeater amplifies the received signal according to the power amplification gain beta and forwards the amplified received signal. In an embodiment, if the sum of P1 and power amplification gain beta is greater than the maximum transmitting power of the repeater, the power amplification gain of the repeater is adjusted as the difference value between the power amplification gain beta and the variable delta, and the repeater amplifies the received signal according to the adjusted power amplification gain, and then forwards the amplified received signal. The variable delta may be determined or preset by receiving a signaling from the base station. The advantage of this method is that it can ensure that the power of the transmitted signal of the repeater will not be greater than the maximum transmitting power of the repeater.

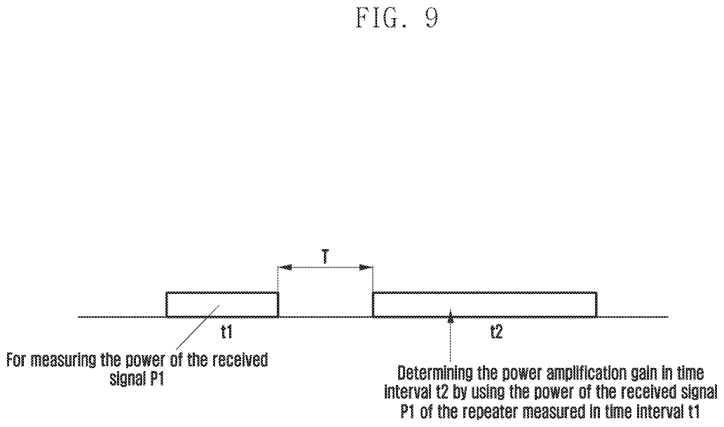

FIG. 9 illustrates a method of measuring a power of a receiving signal of a repeater according to an embodiment of the disclosure.

Referring to FIG. 9, in some examples, the power P1 of the received signal may be measured in the time interval t1, and the measured power P1 of the received signal is used to determine the power amplification gain in the time interval t2, and the interval between the time interval t1 and the time interval t2 is T, wherein t1, t2 and T can be determined by receiving a signaling, preset or determined by implementation of the repeater. By setting t1, t2 and T reasonably, the power of the transmitted signal of the repeater may be ensured as far as possible not to be greater than the maximum transmitting power of the repeater under certain measurement complexity.

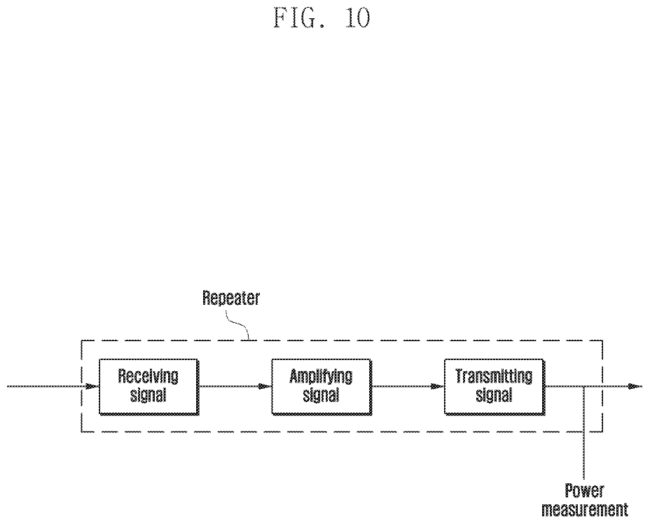

FIG. 10 illustrates a method of adjusting a power amplification gain by measuring a power of a transmitted signal of a repeater according to an embodiment of the disclosure.

Referring to FIG. 10, in some examples, the power P2 of the transmitted signal of the repeater may be measured at the transmitting end of the repeater. In an embodiment, if the measured power P2 of the transmitted signal of the repeater is less than or equal to the maximum transmitting power of the repeater, the repeater amplifies the received signal according to the power amplification gain beta and forwards the amplified signal. In another embodiment, if the measured power P2 of the transmitted signal of the repeater is greater than the maximum transmitting power of the repeater, the power amplification gain of the repeater is adjusted as beta-(P2—the maximum transmitting power of the repeater), and the repeater amplifies the received signal according to the adjusted power amplification gain, and then forwards the amplified signal. The advantage of this method is that the power amplification gain of the repeater can be adjusted in time when the power of the transmitted signal of the repeater is greater than the maximum transmitting power of the repeater, such that the power of the transmitted signal of the repeater is less than or equal to the maximum transmitting power of the repeater.

Referring to FIG. 10, in other examples, if the measured power P2 of the transmitted signal of the repeater is less than or equal to the maximum transmission power of the repeater, the repeater amplifies the received signal according to the power amplification gain beta and forwards the amplified received signal. In an embodiment, if the measured transmitting power P2 of the repeater is greater than the maximum transmitting power of the repeater, the power amplification gain of the repeater is adjusted as the difference value between the power amplification gain beta and a variable delta, and the repeater amplifies the received signal according to the adjusted power amplification gain, and then forwards the amplified received signal. The advantage of this method is that the power amplification gain of the repeater may be adjusted in time when the power of the transmitted signal of the repeater is greater than the maximum transmitting power of the repeater, so that the power of the transmitted signal of the repeater is less than or equal to the maximum transmitting power of the repeater. The variable delta may be determined or preset by receiving a signaling from the base station. The advantage of this method is that it can ensure that the power of the transmitted signal of the repeater will not be greater than the maximum transmitting power of the repeater.

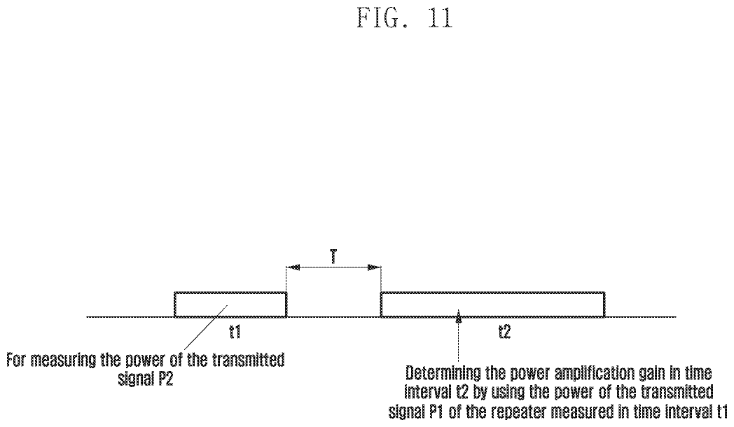

FIG. 11 illustrates a method of measuring a power of a transmitted signal of a repeater according to an embodiment of the disclosure.

Referring to FIG. 11, in some examples, the power P2 of the transmitted signal of the repeater may be measured in the time interval t1, and the measured power P2 of the transmitted signal is used to determine the power amplification gain in the time interval t2, and the interval between the time interval t1 and the time interval t2 is T, wherein t1, t2 and T can be determined by receiving a signaling, preset or determined by implementation of the repeater. By setting t1, t2 and T reasonably, the power amplification gain of the repeater may be adjusted as soon as possible under certain measurement complexity, so that the power of the transmitted signal of the repeater will not be greater than the maximum transmitting power of the repeater. The time intervals t1, t2 and T in this method may be same as or different from t1, t2 and T in the method of measuring the power of the received signal.

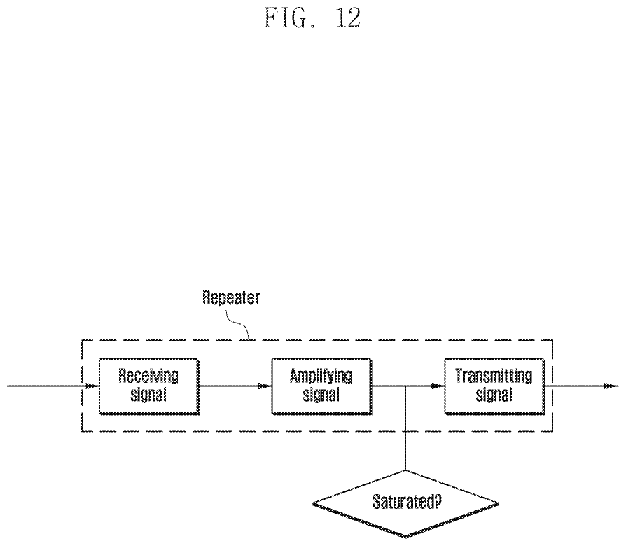

FIG. 12 illustrates a method of adjusting a power amplification gain by confirming whether the power amplifier is saturated according to an embodiment of the disclosure.

Referring to FIG. 12, in some examples, the power amplification gain beta of the repeater may be adjusted according to whether the power amplifier of the repeater is saturated. In another embodiment, if the power amplifier of the repeater is unsaturated, the repeater amplifies the received signal according to the power amplification gain beta and forwards the amplified received signal. In another embodiment, if the power amplifier of the repeater is saturated, the power amplification gain of the repeater is adjusted to be the difference value between the power amplification gain beta and a variable delta, and the repeater amplifies the received signal according to the adjusted power amplification gain, and then forwards the amplified received signal. The variable delta may be determined or preset by receiving a signaling from the base station. The advantage of this method is that it can adjust the power amplification gain in time when the power amplifier of the repeater is saturated, so that the signal forwarded by the repeater is not distorted.

In the above method, the variable delta used for different power amplification gain adjustment methods may be same or different. Additionally, the above method may be used for the power adjustment of the signal forwarded by the repeater from the base station to the UE and can also be used for the power adjustment of the signal forwarded by the repeater from the UE to the base station, but the power control parameters and power adjustment methods in different situations are determined separately.

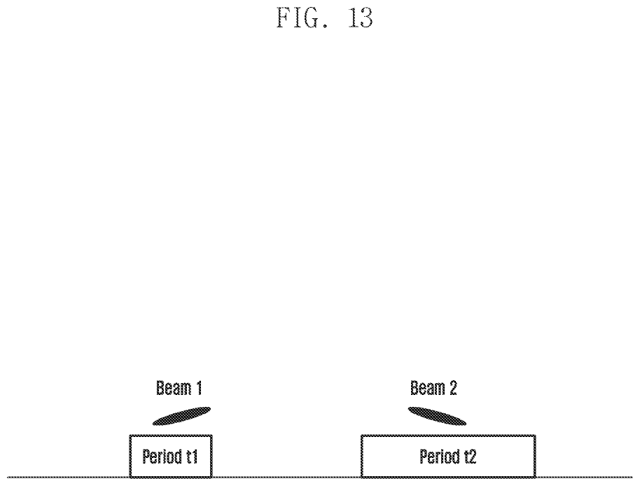

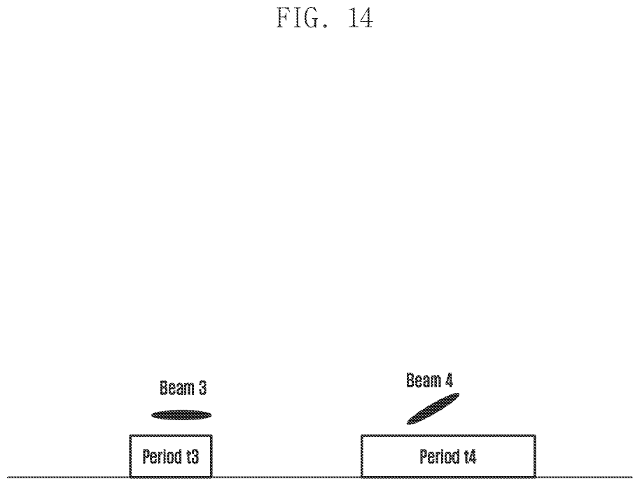

FIGS. 13 and 14 are schematic diagrams illustrating that different beams are used to carry signals at different time periods according to various embodiments of the disclosure.

For different beam situations, the power adjustment of the signal forwarded by the repeater from the base station to the UE and the power adjustment of the signal forwarded by the repeater from the UE to the base station may employ independent power control parameters and independent power adjustment methods. For example, referring to FIG. 13, in the period t1, the repeater uses beam b1 to forward the signal from the base station to the UE, and employs a first set of power control parameters to adjust the power amplification gain of the repeater; in the period t2, the repeater uses beam b2 to forward the signal from the base station to the UE, and employs a second set of power control parameters to adjust the power amplification gain of the repeater.

Referring to FIG. 14, in the period t3, the repeater uses beam b3 to forward the signal from the UE to the base station, and employs a third set of power control parameters to adjust the power amplification gain of the repeater; in time period t4, the repeater uses beam b4 to forward the signal from the UE to the base station, and employs a fourth set of power control parameters to adjust the power amplification gain of the repeater. In some examples, the power control parameters determined for different beams may be same or different. Depending on the beam conditions of different employed beams, the corresponding power control parameters may be determined or preset by receiving a signaling, wherein each set of power control parameters includes the maximum transmitting power and the power amplification gain.

According to some embodiments of the disclosure, the repeater may transmit information related to the measurement result to the base station. In some examples, when the power amplifier of the repeater is saturated, the repeater may transmit information to the base station indicating that the power amplifier of the repeater is saturated. The base station may adjust the power of the signal transmitted by the base station to the repeater or transmit an instruction to adjust its power amplification gain to the repeater according to the information transmitted by the repeater.

In some embodiments, the information related to the measurement result transmitted by the repeater to the base station may include the measured power of the received signal of the repeater, the measured power of the transmitted signal of the repeater, or the sum of the measured power of the received signal of the repeater and the power amplification gain of the repeater.

The occasion for the repeater to transmit the information related to the measurement result to the base station may be configured by signaling, and the repeater transmits the information to the base station at the configured occasion. The occasion may also be triggered by an event, for example, when the sum of the measured power of the received signal of the repeater and the power amplification gain of the repeater is greater than a threshold (for example, the threshold can be the maximum transmitting power of the repeater) or when the measured power of the transmitted signal of the repeater is greater than the maximum transmitting power of the repeater, the repeater transmits the information related to the measurement result to the base station.

The repeater may transmit measurement result related information on the configured physical uplink control channel (PUCCH) resource or the configured or scheduled physical uplink shared channel (PUSCH) resource.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for signal transmission performed by a device for forwarding signals in a communication system, the method comprising:
determining a first power amplification gain; and
forwarding a received signal based on the first power amplification gain.

2. The method of claim 1, further comprising:
prior to determining the first power amplification gain, determining power control parameters,
wherein the power control parameters include a second power amplification gain configured or preset by a base station, or a maximum transmitting power configured or preset by the base station.

3. The method of claim 2,
wherein the maximum transmitting power is configured or preset through a first signaling,
wherein the second power amplification gain is configured or preset through a second signaling,
wherein the first signaling and the second signaling are same signaling or different signaling, and
wherein the power control parameters are configured for each beam for carrying signals.

4. The method of claim 2, wherein the determining of the first power amplification gain comprises:
measuring a power of the received signal or a power of a transmitted signal; and
determining the first power amplification gain according to a measurement result.

5. The method of claim 4, wherein the determining of the first power amplification gain comprises:
for a beam carrying the signal, measuring the power of the received signal or the power of the transmitted signal on the beam;
determining the first power amplification gain corresponding to the beam according to the measurement result;
measuring the power of the received signal in a first time interval; and
determining the first power amplification gain according to the measured power of the received signal in a second time interval after the first time interval.

6. The method of claim 4, wherein the determining of the first power amplification gain comprises:
measuring the power of the transmitted signal in a third time interval; and
determining the first power amplification gain according to the measured power of the transmitted signal in a fourth time interval after the third time interval.

7. The method of claim 4, wherein the determining of the first power amplification gain comprises:
determining the first power amplification gain according to the power control parameters and the measured power of the received signal; or
determining the first power amplification gain according to the power control parameters and the measured power of the transmitted signal.

8. The method of claim 7, wherein the determining of the first power amplification gain according to the power control parameters and the measured power of the received signal comprises:
if a sum of the measured power of the received signal and the second power amplification gain is greater than the maximum transmitting power, determining that the first power amplification gain is a difference value between the maximum transmitting power and the measured power of the received signal, or determining that the first power amplification gain is a difference value between the second power amplification gain and a first variable.

9. The method of claim 7, wherein the determining of the first power amplification gain according to the power control parameters and the measured power of the received signal further comprises:
if a sum of the measured power of the received signal and the second power amplification gain is less than or equal to the maximum transmitting power, determining that the first power amplification gain is the second power amplification gain; and
if the measured power of the transmitted signal is greater than the maximum transmitting power, determining that the first power amplification gain is the second power amplification gain minus a difference value between the measured power of the transmitted signal and the maximum transmitting power, or determining that the first power amplification gain is a difference value between the second power amplification gain and a second variable.

10. The method of claim 7, wherein the determining of the first power amplification gain according to the power control parameters and the measured power of the transmitted signal further comprises:
if the measured power of the transmitted signal is less than or equal to the maximum transmitting power, determining that the first power amplification gain is the second power amplification gain; and
determining the first power amplification gain according to whether a power amplifier for amplifying power in the device for forwarding signals is saturated.

11. The method of claim 10, wherein the determining of the first power amplification gain according to whether the power amplifier for amplifying power in the device for forwarding signals is saturated comprises:
if the power amplifier for amplifying power in the device for forwarding signals is saturated, determining that the first power amplification gain is a difference value between the second power amplification gain and a third variable; and
if the power amplifier for amplifying power in the device for forwarding signals is unsaturated, determining that the first power amplification gain is the second power amplification gain.

12. The method of claim 4, further comprising:
transmitting, to the base station, information related to the measurement result; or
in a case that a power amplifier for amplifying power is saturated, transmitting, to the base station, information indicating that the power amplifier for amplifying power is saturated.

13. The method of claim 12, wherein the information related to the measurement result includes at least one of the following information:
the measured power of the received signal, the measured power of the transmitted signal; and
a sum of the measured power of the received signal and the second power amplification gain.

14. The method of claim 12, wherein a transmitting occasion of the information related to the measurement result is triggered by signaling configuration or an event.

15. The method of claim 14, wherein the event comprises:
a sum of the measured power of the received signal and the second power amplification gain is greater than a threshold; or
the measured power of the transmitted signal is greater than the maximum transmitting power.
